(19) United States
(12) Patent Application Publication
(10) Pub. No.: US 2026/0119368 A1
(43) Pub. Date: Apr. 30, 2026

(54) METHOD FOR INCREASING COMPUTING SPEED WHEN SOLVING CONSTRAINT-BASED ONE-TO-MANY MATCHING PROBLEMS

(71) Applicant: INTUIT INC., Mountain View, CA (US)

(72) Inventors: Natalie Bar ELIYAHU, Petah Tikva (IL); Shon MENDELSON; Lior TABORI, Petah Tikva (IL); Hadas BAUMER, Petah Tikva (IL)

(73) Assignee: INTUIT INC., Mountain View, CA (US)

(21) Appl. No.: 18/932,592

(22) Filed: Oct. 30, 2024

(51) Int. Cl. G06F 11/36; G06F 16/2455; G06F 16/28

(52) U.S. Cl. CPC G06F 11/3608; G06F 16/24565; G06F 16/288

(57) ABSTRACT

A method including receiving a processor command to execute a constraint-based one-to-many matching problem including matching a source entity to target entities selected from test entities. A matching machine learning model is executed on the source entity and the test entities to generate scores representing degrees of match between the source entity and corresponding ones of the test entities. The test entities are arranged in an ordered list according to the scores. A greedy optimization algorithm, that is constrained by the constraint to generate combinations of the test entities, is executed. Each of the combinations satisfies the constraint. The method also includes selecting, from among the combinations of the test entities, an optimized combination of test entities from among the combinations of test entities. The optimized combination of test entities is optimized relative to the constraint. The optimized combination of test entities is stored as the target entities.

### BACKGROUND

Constraint-based one-to-many matching problems may represent challenging computer science problems due to the number of calculations involved. For example, a practical constraint-based one-to-many matching problem may require so many calculations that even modern computers is unable to solve the problem.

To highlight the technical challenge, a brief description of the constraint-based one-to-many matching problem is presented. The problem involves matching a source entity to combinations of multiple test entities in order to find a group of target entities (selected from the test entities) that most closely satisfies a constraint. A practical example of the problem may be matching a single invoice (the source entity) to a specific set of transactions (the target entities), that are selected from among a much larger group of available transactions (the test entities), that most closely matches the dollar amount (the constraint) of the single invoice. Note that the example is presented to exemplify the constraint-based one-to-many matching problem, not to describe a financial matching problem.

Solving the problem uses a number of calculations equal to roughly 2^{N}, where “N” is the number of test entities. Thus, if fifty test entities exist, then the number of calculations used to solve the problem is over one quadrillion (above 1,125,000,000,000,000). If 100 test entities exist, then the number of calculations used to solve the problem is over one nonillion (10³⁰), which is well beyond the power of modern computers. In many practical applications, thousands of test entities may exist (requiring more than 10³⁰¹ calculations). Thus, modern computers are wholly incapable of solving the problem in such applications. Accordingly, a serious technical challenge is faced when attempting to use a computer to solve the constraint-based one-to-many matching problem.

### SUMMARY

One or more embodiments provide for a method. The method includes receiving a processor command to execute a constraint-based one-to-many matching problem including matching a source entity to target entities selected from test entities. The constraint-based one-to-many matching problem further includes a constraint that constrains permitted combinations of the target entities. The method also includes executing a matching machine learning model on the source entity and the test entities to generate scores representing degrees of match between the source entity and corresponding ones of the test entities. The method also includes arranging the test entities in an ordered list according to the scores. The method also includes executing a greedy optimization algorithm that is constrained by the constraint to generate combinations of the test entities. Each of the combinations satisfies the constraint. The method also includes selecting, from among the combinations of the test entities, an optimized combination of test entities from among the combinations of test entities. The optimized combination of test entities is optimized relative to the constraint. The method also includes storing the optimized combination of test entities as the target entities.

One or more embodiments also provide for a system. The system includes a computer processor and a data repository in communication with the computer processor. The data repository stores a processor command to execute a constraint-based one-to-many matching problem including matching a source entity to target entities selected from test entities. The constraint-based one-to-many matching problem further includes a constraint that constrains permitted combinations of the target entities. The data repository also stores scores representing degrees of match between the source entity and corresponding ones of the test entities. The data repository also stores combinations of the test entities. The data repository also stores an optimized combination of test entities. The optimized combination of test entities is optimized relative to the constraint. The system also includes a matching machine learning model which, when executed by the computer processor on the source entity and the test entities, generate the scores. The system also includes a greedy optimization algorithm which, when executed by the computer processor, is constrained by the constraint to generate the combinations of test entities. Each of the combinations satisfies the constraint. The system also includes a server controller which, when executed by the computer processor, performs a computer-implemented method. The computer-implemented method includes arranging the test entities in the ordered list according to the scores. The computer-implemented method also includes selecting, from among the combinations of the test entities, the optimized combination of test entities from among the combinations of test entities. The computer-implemented method also includes storing the optimized combination of test entities as the target entities.

One or more embodiments provide for another method. The method includes receiving a processor command to execute a constraint-based one-to-many matching problem including matching a source entity to target entities selected from test entities. The constraint-based one-to-many matching problem further includes a constraint that constrains permitted combinations of the target entities. The target entities includes a first number of the target entities and the test entities includes a second number of the test entities. The first number of the target entities is less than the second number of the test entities. The method also includes executing a matching machine learning model on the source entity and the test entities to generate scores representing degrees of match between the source entity and corresponding ones of the test entities. The method also includes arranging the test entities in an ordered list according to the scores. The method also includes executing a greedy optimization algorithm constrained by the constraint to generate combinations of the test entities. Each of the combinations satisfies the constraint. The greedy optimization algorithm is executed once for each of a number of the test entities and, on each execution of the greedy optimization algorithm, initiation of the greedy optimization algorithm begins with a subsequent test entity in the ordered list. The combinations of the test entities includes each of sets of combinations of test entities generated by executions of the greedy optimization algorithm on the test entities. The method also includes selecting, from among the combinations of the test entities, an optimized combination of test entities from among the combinations of test entities. The optimized combination of test entities is optimized relative to the constraint. The method also includes storing the optimized combination of test entities as the target entities.

Other aspects of one or more embodiments will be apparent from the following description and the appended claims.

### BRIEF DESCRIPTION OF DRAWINGS

FIG. 1 shows a computing system, in accordance with one or more embodiments.

FIG. 2 shows a flowchart of a method for increasing computing speed when solving constraint-based one-to-many matching problems, in accordance with one or more embodiments.

FIG. 3A shows the technical challenge of using a computer to solve constraint-based one-to-many matching problems in practical applications, in accordance with one or more embodiments.

FIG. 3B and FIG. 3C show methods for using a computer to solve constraint-based one-to-many matching problems, in accordance with one or more embodiments.

FIG. 4A and FIG. 4B show an example of a computing system, in accordance with one or more embodiments.

Like elements in the various figures are denoted by like reference numerals for consistency.

### DETAILED DESCRIPTION

One or more embodiments are directed to computer programming techniques which permit a computer to solve a constraint-based one-to-many matching problem in a practical computing application, such as when “N” (i.e., the number of test entities) exceeds fifty or more (in which the ordinary computer algorithm for solving the constraint-based one-to-many matching problem exceeds 2⁵⁰ calculations, which is above one quadrillion calculations). More specifically, one or more embodiments present a procedure that reduces the number of calculations used in solving the constraint-based one-to-many matching problem to an order of “N”, plus the computing power used to execute a matching machine learning model. In other words, if the number of test entities is 1000, then one or more embodiments permit a computer to use roughly 1000 calculations to solve the constraint-based one-to-many matching problem, plus the computing power used to execute the matching algorithm (typically several million calculations). However, several million calculations, or even one hundred million calculations, is a vanishingly small number compared to the 10³⁰¹ calculations that would be used to directly solve the constraint-based one-to-many matching problem when 1000 test entities are present.

Thus, one or more embodiments address the technical problem of modern computers being unable to solve the constraint-based one-to-many matching problem in practical applications (e.g., where the number of test entities is fifty or above) because the overwhelming number of calculations to be performed. One or more embodiments effectively speed up a computer dramatically (e.g., by many orders of magnitude) when solving the constraint-based one-to-many matching problem. Stated differently, for practical applications where the number of text entities may exceed one million, a modern computer may use one or more embodiments to solve the constraint-based one-to-many matching problem, whereas without one or more embodiments such a problem cannot be solved by a computer.

Briefly, one or more embodiments use a matching machine learning model on the source entity and the test entities to generate scores representing degrees of match between the source entity and corresponding ones of the test entities. Note that such a matching model does not solve the constraint-based one-to-many matching problem because a combination of the test entities may represent the solution to the problem. However, the matching does permit the creation of an ordered list of the test entities, arranged in order of the scores.

One or more embodiments then execute a type of mathematical optimization algorithm known as a greedy optimization algorithm. The greedy optimization algorithm is constrained by the constraint defined by the constraint-based one-to-many matching problem. The greedy optimization algorithm generates combinations of the test entities.

One or more embodiments then select from among the combinations of the test entities, an optimized combination of the test entities. The optimized combination is the combination of test entities which most closely satisfies the constraint. The optimized combination of test entities may be referred to as target entities. The target entities represent the solution to the constraint-based one-to-many matching problem, though the process of achieving the solution is much more efficient. Accordingly, the computer is improved and is able to perform the constraint-based one-to-many matching problem even when the number of test entities, “N,” exceeds 50, 100, 1000, or more.

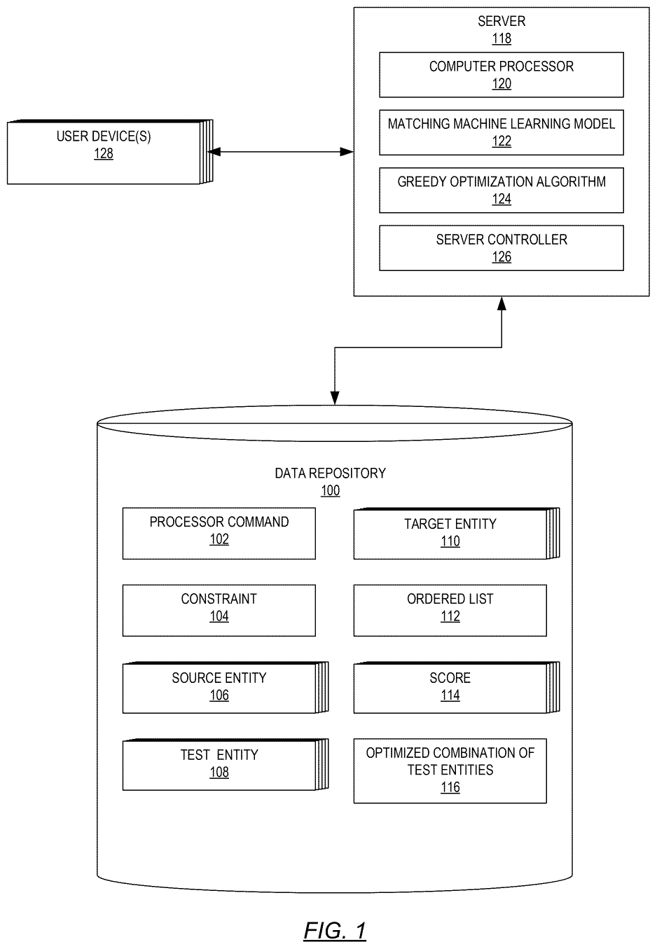

Attention is now turned to the figures. FIG. 1 shows a computing system, in accordance with one or more embodiments. The system shown in FIG. 1 includes a data repository (100). The data repository (100) is a type of storage unit or device (e.g., a file system, database, data structure, or any other storage mechanism) for storing data. The data repository (100) may include multiple different, potentially heterogeneous, storage units and/or devices.

The data repository (100) stores a processor command (102). The processor command (102) is a computer readable command to a computer processor (120) to execute a constraint-based one-to-many matching problem. The constraint-based one-to-many matching problem is a mathematical problem to match a source entity (106) to two or more target entities (e.g., target entity (110)) selected from two or more test entities (e.g., test entity (108)) within a constraint (e.g., constraint (104)) that constrains permitted combinations of the test entities (e.g., test entity (108)).

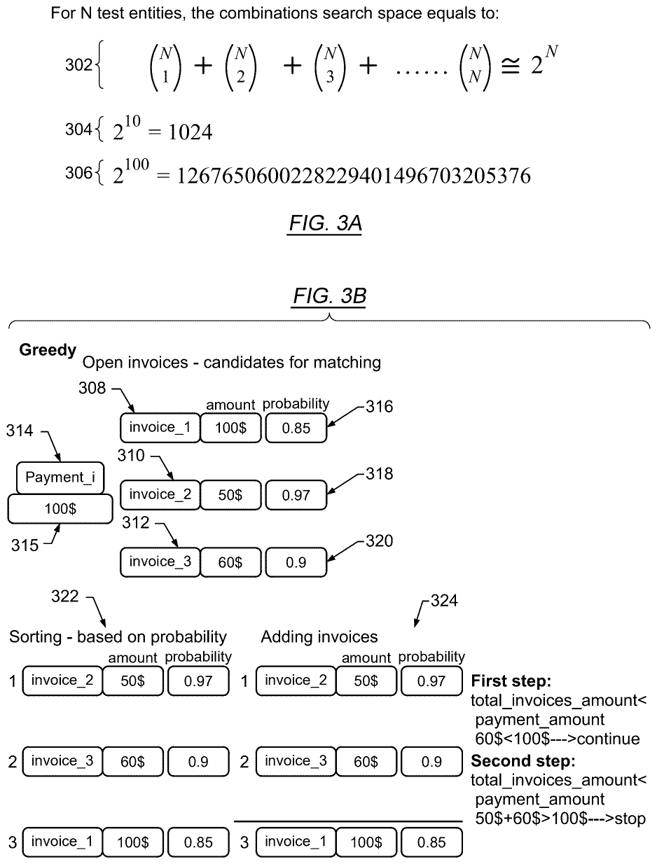

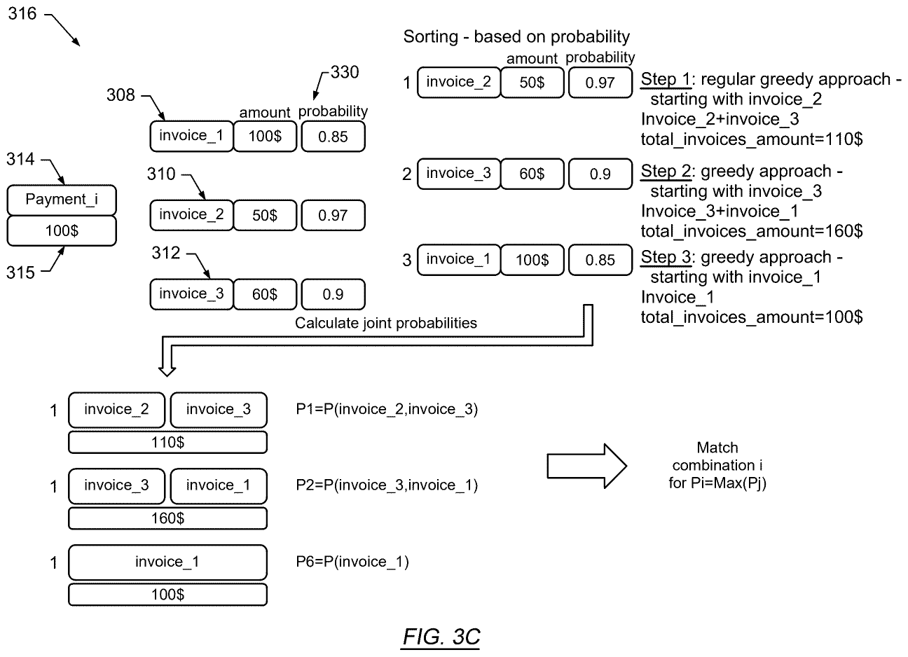

The data repository (100) also may store the constraint (104). The constraint (104) is a numerical value or a mathematical expression that places one or more limits on the possible combinations of the test entities when evaluating. If a combination of the test entities does not satisfy the constraint (104), then that combination is not permitted to be considered a candidate for being a group of target entities that forms an optimized combination of test entities (116) (defined below). An example of the constraint (104) may be a constraint value which may not be exceeded when adding test values of combinations of test entities (such as test entity (108)). Another example of the constraint (104) is described with respect to FIG. 3C.

Attention is now turned to the source entity (106), the test entity (108), and the target entity (110). As used herein the term “entity” refers to a data structure in which a value is stored. The data structure may represent an object or thing, and the value represents some aspect of the object or thing. For example, an entity may be a physical sample, an invoice, a transaction, a scientific property, etc. In turn, the value is a number that represents some aspect of the object or thing, such as a measurement value, an invoice or transaction amount, etc.

The data repository (100) also may store a source entity (106). The source entity (106) is an entity having a value that defines, at least in part, the constraint (104). There may be multiple source entities, of which the source entity (106) is one. For example, it is possible that the constraint (104) is defined by a combination of values of multiple source entities. However, a single instance of the source entity (106) may have a value that defines the constraint (104). For example, the source entity (106) may be an invoice and the total dollar amount of the invoice may be the constraint (104).

The data repository (100) also may store a test entity (108). The test entity (108) is an entity which, possibly in combination with one or more other test entities, may form the optimized combination of test entities (116) defined below. In other words, the test entity (108) is an entity which may be one of target entities that, together, form the optimized combination of test entities (116). For example, the test entity (108) may be a transaction value (of several transactions) if the source entity (106) is in invoice billable to multiple transactions (of which one or more may be associated with the test entity (108)). Many test entities may be present (e.g., 40, 50, 100, 1000, or more test entities).

The data repository (100) also may store a target entity (110). The target entity (110) is a test entity (108) that has been determined to be one of possibly several test entities that, together, form the optimized combination of test entities (116). Thus, each of the test entities that forms the optimized combination of test entities (116) is considered to be one of the target entities.

In many embodiments, there are more test entities than there are possible target entities. Thus, there are more test entities than a number of the test entities that exist in the optimized combination of test entities (116).

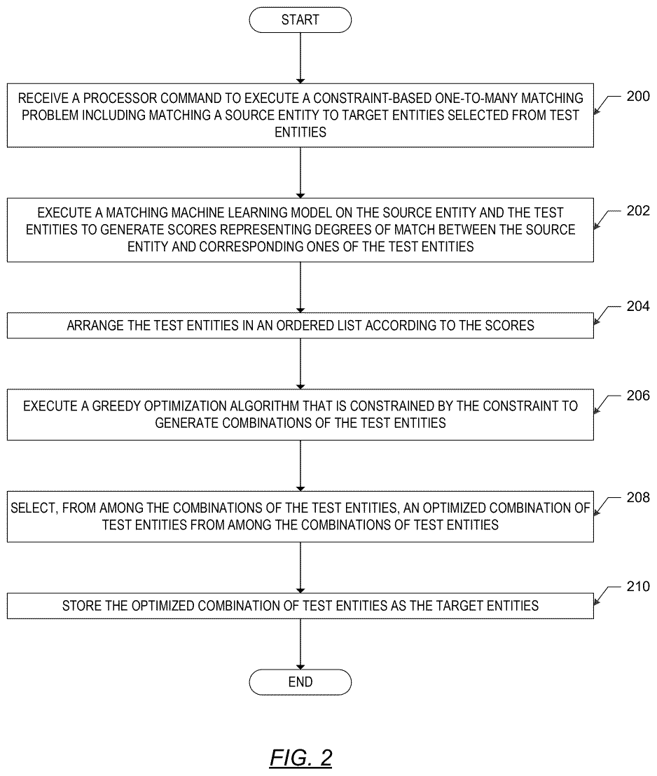

In an embodiment, there are 50 or more test entities, representing more test entities than a modern computer can match without using the method of FIG. 2. In a practical application, such as in an enterprise level financial management software service, there may be 10,000 or more test entities for a single organization being served by the service (which would use more than 103010 calculations to solve using the existing method for solving the constraint-based one-to-many matching problem).

The data repository (100) also may store an ordered list (112). The ordered list (112) is a list of the test entities (e.g., the test entity (108)) sorted according to scores assigned to the test entities. The ordered list (112) may be arranged from a highest score to a lowest score. Each score is determined by a matching machine learning model (122), as described with respect to FIG. 2.

The data repository (100) also may store a score (114). The score (114) is a value that represents a degree of match between a test entity (108) and the source entity (106). The score (114) is determined by the matching machine learning model (122), as described with respect to FIG. 2. Thus, for example, a score of 0.99 represents a high probability (assuming a score of 1.0 is a perfect match) that the test entity (108) matches, or is associated with, the source entity (106).

The data repository (100) also may store an optimized combination of test entities (116). The optimized combination of test entities (116) is one or more of the test entities (e.g., the test entity (108)) that, when combined, have values that most closely match the constraint (104) of the source entity (106). The optimized combination of test entities (116) is evaluated according to the method of FIG. 2. Thus, for example, should multiple combinations of the test entities exactly equal the constraint (104), then the optimized combination of test entities (116) will be the combination of the test entities that have the highest scores (e.g., the score (114)).

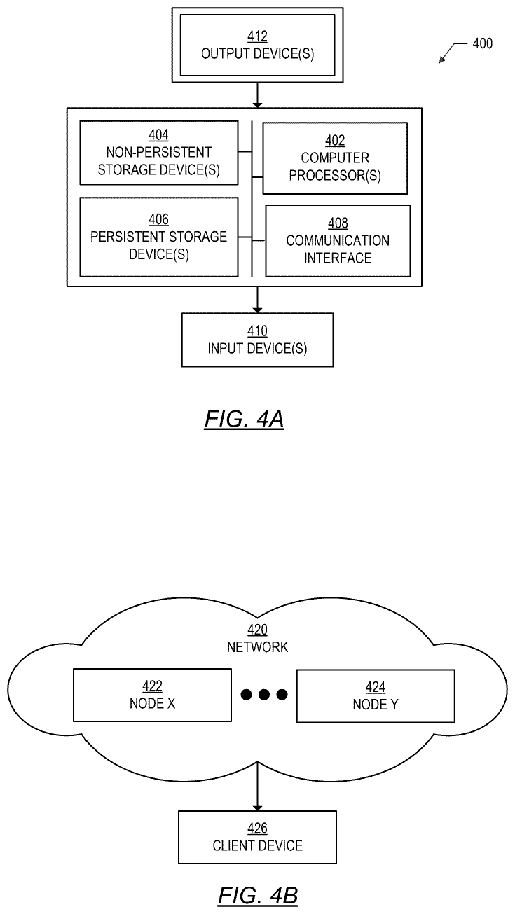

The system shown in FIG. 1 may include other components. For example, the system shown in FIG. 1 also may include a server (118). The server (118) is one or more computer processors, data repositories, communication devices, and supporting hardware and software. The server (118) may be in a distributed computing environment. The server (118) is configured to execute one or more applications, such as the matching machine learning model (122) or the greedy optimization algorithm (124). An example of a computer system and network that may form the server (118) is described with respect to FIG. 4A and FIG. 4B.

The server (118) includes a computer processor (120). The computer processor (120) is one or more hardware or virtual processors which may execute computer readable program code that defines one or more applications, such as the matching machine learning model (122) or the greedy optimization algorithm (124). An example of the computer processor (120) is described with respect to the computer processor(s) (402) of FIG. 4A.

The server (118) also includes a matching machine learning model (122). The matching machine learning model (122) is a machine learning model programmed to match on set of data (e.g., the test entity (108)) to another set of data (e.g., the source entity (106)). Specifically, the matching machine learning model (122) is programmed to assign a score (e.g., the score (114)) that ranges from zero to one to the test entity (108). The higher the score (114), the greater the likelihood of a match between the source entity (106) and the test entity (108).

For example, the matching machine learning model (122) may be an XGBoost machine learning model when the source entity (106) is an invoice and the test entity (108) (and other test entities) are transactions that may, or may not, correspond to the source entity (106). In this example, the matching machine learning model (122) may determine a probability that one of the test entities (i.e., a transaction) is one of the transactions that forms the total value of the source entity (i.e., the invoice which reflects multiple transactions). Specifically, each row of input may be a payment (the test entity (108)), and the invoice (source entity (106)), together with relevant features related to matching the test entity (108) to the source entity (106). The relevant features may be, for example, differences in amounts, creation dates of the source entity (106) and the test entity (108), the names of parties associated with to the source entity (106) and the test entity (108), etc.

Note that the score (114), even combined with all other scores of all other test entities, is not sufficient to solve the constraint-based one-to-many matching problem. For example, all of the test entities could have scores above 0.8 (representing an 80% likelihood of match), even if the combination of all test entities would far exceed the total value of the source entity (106) (thereby violating the constraint (104)). Solution of the constraint-based one-to-many matching problem in the context of one or more embodiments is described with respect to FIG. 2.

The server (118) also includes a greedy optimization algorithm (124). The greedy optimization algorithm (124) is software or application specific hardware which, when executed by the computer processor (120), performs a greedy optimization procedure. The greedy optimization procedure is described with respect to FIG. 2.

The server (118) also may include a server controller (126). The server controller (126) is software or application specific hardware which, when executed by the computer processor (120), controls and coordinates operation of the software or application specific hardware described herein. Thus, the sever controller (126) may control and coordinate execution of matching machine learning model (122) and the greedy optimization algorithm (124). The server controller (126) also may perform the method of FIG. 2.

The system shown in FIG. 1 also may include one or more user devices (128). The user devices (128) may be considered remote or local. A remote user device is a device operated by a third-party that does not control or operate the system of FIG. 1. Similarly, the organization that controls the other elements of the system of FIG. 1 may not control or operate the remote user device. Thus, a remote user device may not be considered part of the system of FIG. 1.

In contrast, a local user device is a device operated under the control of the organization that controls the other components of the system of FIG. 1. Thus, a local user device may be considered part of the system of FIG. 1.

In any case, the user devices (128) are computing systems (e.g., the computing system (400) shown in FIG. 4A) that communicate with the server (118). Thus, for example, the user devices (128) may be used to control operation of the matching machine learning model (122), the greedy optimization algorithm (124), or the server controller (126). In another embodiment, one or more of the user devices (128) may be operated by a computer technician that services the various components of the system shown in FIG. 1.

While FIG. 1 shows a configuration of components, other configurations may be used without departing from the scope of one or more embodiments. For example, various components may be combined to create a single component. As another example, the functionality performed by a single component may be performed by two or more components.

FIG. 2 shows a flowchart of a method for increasing computing speed when solving constraint-based one-to-many matching problems, in accordance with one or more embodiments. The method of FIG. 2 may be implemented using the system of FIG. 1 and one or more of the steps may be performed on or received at one or more computer processors.

Step 200 includes receiving a processor command to execute a constraint-based one-to-many matching problem including matching a source entity to target entities selected from test entities. The command may be received from a user device for from some automated process also being executed by the server or by some other computing device that calls the server to execute the constraint-based one-to-many matching problem.

As indicated with respect to FIG. 1, the constraint-based one-to-many matching problem includes a constraint that constrains permitted combinations of the target entities. There are a first number (e.g., 101) of the target entities and a second number (e.g., 503) of the test entities. However, in most cases, the first number of the target entities is less than the second number of the test entities. In other words, the solution to the constraint-based one-to-many matching problem involves a subset of the test entities (i.e., the target entities) that is fewer than the total number of test entities.

Mathematically, the constraint-based one-to-many matching problem may be characterized as follows:

$$Max C ( Match : {OFX}_{i} \to [ {S}_{1} , {S}_{1} , … {S}_{n} ]$$

$$S . T : {\sum }_{1}^{n} {S}_{Amount} \geq {OFX}_{i} \_Amount$$

Where “C” is the constraint, “OFX” represents the test entities, “S” is a set of source entities (which may be one or more source entities), “S_{Amount}” is the sum of the values of the source entities, and “OFXᵢ_Amount” is the sum of the values of the test entities.

Step 202 includes executing a matching machine learning model on the source entity and the test entities to generate scores representing degrees of match between the source entity and corresponding ones of the test entities. Executing the matching machine learning model may be performed by receiving an input, commanding a processor to execute the matching machine learning model on the input, and then receiving an output of the matching machine learning model. The input may be a vector that includes the test entities, the source entity, the constraint, and relevant features. The term “relevant features” is defined with respect to the matching machine learning model (122) of FIG. 1. The output of the matching machine learning model is a vector that represents the test entities and a corresponding score for each of the test entities.

As indicated above, the score represents a probability that a given test entity is related to the source entity. As a particular example, the score may represent the probability that a transaction amount (i.e., a test entity) is one of several transactions presented in one invoice (i.e., a source entity).

Step 204 includes arranging the test entities in an ordered list according to the scores. For example, the test entities may be arranged in a descending order of scores, from a highest scored test entity to a lowest score test entity. Arranging the test entities may be performed by a server controller, such as, for example, by executing a spreadsheet program or other data sorter that sorts data columns according to the entries in one of the columns.

Step 206 includes executing a greedy optimization algorithm that is constrained by the constraint to generate combinations of the test entities. Thus, each of the combinations of the test entities satisfies the constraint. The greedy optimization algorithm is exemplified in FIG. 3B.

Briefly, the greedy optimization algorithm involves an iterative process. Starting with the first test entity, if the test entity value is greater than or equal to the ‘constraint,’ the process stops. Otherwise, the process continues to add the values of test entities to the match list until the constraint is fulfilled or the constraint is violated. In other words, the process continues until the total value of the test entities is greater than or equal to the constraint.

At that point, the process terminates. The set of test entities that remain, less any test entity that caused the constraint to be violated, is considered the set of target entities.

The computational complexity of the greedy optimization method is now addressed. Considering the sorted nature of the candidate list with source entity amounts also factored into the model, a reasonable assumption is that a constant “C” (where “C” is significantly smaller than “N”, the number of test entities) would suffice to meet the constraint. The time complexity of the algorithm is O(C)=O(1), which, for values of “N” greater than 10, is many orders of magnitude less than the direct solution to the constraint-based one-to-many matching problem. The computational savings increases exponentially with the value of “N,” the number of test entities.

Another variant of the greedy optimization may be used in cases where “N” is less than the computational resources available to solve a number of calculations of order “N” (e.g., where “N” is a million or fewer, for example, for most servers). The following variant, in some embodiments, may be more accurate when solving the constraint-based one-to-many matching problem.

In the variant, also known as a dynamic greedy optimization algorithm, the process described above is repeated for each of the test entities, starting each time with a new test entity in the ordered list. Thus, the dynamic greedy optimization algorithm may consider all possible starting points, unlike the greedy algorithm that returns the first solution when starting with the first test entity.

The dynamic greedy optimization algorithm, like the greedy optimization algorithm, starts with the first invoice as a starting point and calculates the matching joint probability. However, in each following round, the dynamic greedy optimization algorithm repeats the greedy algorithm, but with another initial test entity (e.g., in the second iteration, the second test entity on the ordered list is considered as the starting point and the first test entity is ignored or is treated as being at the end of the ordered list).

The process continues until the final test entity is considered as a starting point. Although the dynamic greedy optimization algorithm may be more precise than the greedy algorithm, it comes with a higher complexity, requiring O(N) time complexity since the dynamic greedy optimization algorithm considers “N” starting points. Modern computers can solve problems requiring O(N) time where “N” is on the order of billions or less, possibly as high as trillions. However, O(N) may be many orders of magnitude less than O(2^{N}), which is the number of calculations used to directly solve the constraint-based one-to-many matching problem. Specifically, the computational savings of the one or more embodiments increases exponentially with the value of “N” (the number of test entities). Accordingly, for values of “N” exceeding 50 or more, one or more embodiments may solve the constraint-based one-to-many matching problem using a computer, whereas such constraint-based one-to-many matching problems are impossible to solve directly using a computer.

Stated differently, the dynamic greedy optimization algorithm is executed a number of times according to a number of the test entities. Each iteration of the greedy optimization algorithm begins with a next test entity in the ordered list. The dynamic greedy optimization algorithm is executed once for each of a number of the test entities and, on each execution of the dynamic greedy optimization algorithm, initiation of the dynamic greedy optimization algorithm begins with a subsequent test entity in the ordered list. FIG. 3C shows an example of the dynamic greedy optimization algorithm.

Step 208 includes selecting, from among the combinations of the test entities, an optimized combination of test entities from among the combinations of test entities. The optimized combination of test entities is optimized relative to the constraint. The process of selecting may be performed differently depending on whether the greedy optimization algorithm is used or the dynamic greedy optimization algorithm is used.t

When the greedy optimization algorithm is used, the optimized combination of test entities (i.e., the set of target entities) is the solution to the greedy optimization algorithm. In other words, when the greedy optimization algorithm is used, the solution is the set of test entities that is in the matching set upon termination of the greedy optimization algorithm. In this case, the set of test entities that is in the matching set upon termination of the greedy optimization algorithm is the set of target entities.

When the dynamic greedy optimization algorithm is used, the optimized combination of test entities (i.e., the set of target entities) is one set of matching test entities, among the resulting multiple sets of matching test entities, that most closely satisfies the constraint. In other words, the dynamic greedy optimization algorithm generates multiple candidate sets of target entities. The optimized combination of test entities (i.e., the target entities) is the one set from among the multiple candidate sets of target entities that most closely matches the constraint.

In still another variation, multiple sets of candidate test entities may exactly match the constraint or may be within a threshold degree of matching the constraint. In the variation, the multiple sets of candidate test entities may be presented to a user and the user may select the optimized combination of test entities (i.e., the set of target entities) from among the multiple sets of candidate test entities that exactly match the constraint. Alternatively, some other process (e.g., the matching machine learning model (122) from FIG. 1) may determine which of the sets of candidate test entities that matches the constraint (either exactly or within a threshold amount) should be selected as the optimized combination of test entities (i.e., the set of target entities).

Step 210 includes storing the optimized combination of test entities as the target entities. The optimized combination of test entities may be stored in a data repository, such as the data repository (100), or in a non-transitory computer readable storage medium, such as the persistent storage device(s) (406) of FIG. 4A. In an embodiment, step 210 may instead be replaced by transmitting the optimized combination of test entities to some other algorithm or computing device for further processing.

Step 210 also may include generating a data structure that stores information indicating that the source entity is matched to the target entities. The data structure may be transmitted to an information processing algorithm. The data structure may include additional information, such as, but not limited to, the source entity, the target entities, the test entities, or the relevant features used by the matching machine learning model (122) to perform the matching at step 202.

As indicated above, the constraint-based one-to-many matching problem, when directly matching the source entity to the test entities, has a first computational complexity on a first complexity order of 2^{N}. “N” represents a number of the test entities. “N” may be at least 50. In contrast, the constraint-based one-to-many matching problem, when executing i) the matching machine learning model, ii) arranging the test entities, and iii) executing the greedy optimization algorithm, has a second computational complexity on a second complexity order of “1” when using the greedy optimization algorithm and a second complexity order of “N” when using the dynamic greedy optimization algorithm. The computational complexity of the matching machine learning model (122) may be added to the computational complexity of the overall process of the method of FIG. 2; however, the computational complexity of the machine learning model process may be considered within the resources of many modern computers. Thus, with the computational complexity of the constraint-based one-to-many matching problem greatly reduced, the method of FIG. 2 may dramatically speed up execution of the computer processor with respect to solving the constraint-based one-to-many matching problem.

While the various steps in the flowchart of FIG. 2 are presented and described sequentially, at least some of the steps may be executed in different orders, may be combined or omitted, and at least some of the steps may be executed in parallel. Furthermore, the steps may be performed actively or passively.

FIG. 3A illustrates the technical challenge of using a computer to solve constraint-based one-to-many matching problems in practical applications, in accordance with one or more embodiments. FIG. 3B and FIG. 3C illustrate methods for using a computer to solve constraint-based one-to-many matching problems, in accordance with one or more embodiments. Thus, together, FIG. 3A through FIG. 3C shows an example of increasing computing speed when solving constraint-based one-to-many matching problems, in accordance with one or more embodiments. The following example is for explanatory purposes only and not intended to limit the scope of one or more embodiments.

FIG. 3A shows the difficulty of solving the constraint-based one-to-many matching problem for as few as 100 test cases. The number of calculations used is shown in line 302, and as shown constitutes about 2^{N} calculations, where “N” is the number of test entities. As can be seen at line 304, if there are 10 test entities, then there are 1,024 combinations, which a modern computer can process quickly. However, as shown at line 306, if there are 100 test entities, then there are about 1.3 nonillion (10³⁰) calculations to be performed to directly solve the constraint-based one-to-many matching problem. Even a supercomputer capable of 10¹⁸ calculations per second would still require roughly three million years to solve the problem directly, effectively making the constraint-based one-to-many matching problem impossible to solve without one or more embodiments. In a realistic computing environment in which there may be thousands, or even millions, of test entities, the constraint-based one-to-many matching problem simply cannot be solved directly by a computer.

However, one or more embodiments shown above involve, at most, O(N) calculations to process the dynamic greedy optimization algorithm. Thus, the overall process uses O(N) (e.g., 1000 if there are 1000 test entities), plus the computational cost of processing the matching machine learning model. Thus, one or more embodiments may be used to improve a computer to solve the constraint-based one-to-many matching problem, even when the number of test entities is in the millions, billions, or more.

FIG. 3B shows an example of the greedy optimization algorithm described with respect to step 206 of FIG. 2. In the example of FIG. 3B, each of the invoices (invoice 1 (308), invoice 2 (310), and invoice 3 (312)) is a test entity. The source entity is a payment (314) received, the deposit representing funds received in payment of the invoices. The constraint is the total amount (315) of the deposit. An initially unknown number of invoices (i.e., target entities) together represent a solution to the constraint-based one-to-many matching problem. Specifically, the problem is finding the set multiple of invoices that, together, match the constraint of the payment from among all invoices.

Note that the constraint-based one-to-many matching problem of FIG. 3B is trivial, because N=3. However, even when N=20 the problem becomes unmanageable for a human to solve directly and when N=50 the problem is impossible for a computer to solve.

In the example, each of the invoices (test entities) is scored by a matching machine learning model, as indicated by the probabilities (probability (316), probability (318), and probability (320)). The invoices are arranged in descending order of probability (i.e., beginning with the highest probability), as indicated in column (322).

Columns (324) show the greedy optimization algorithm. In the first step, the invoice 2 (310) satisfies the constraint as the invoice amount is $50, and the total payment is $100. The next invoice in the ordered list, invoice 3 (312) is $60. If the amount of invoice 3 (312) ($60) is added to the amount of invoice 2 (310) ($50), then the constraint would be violated. Thus, the process stops. The returned invoice of $50 satisfies the constraint, even though the total payment amount is $100.

In this event, an error may be returned. Alternatively, the computationally more expensive dynamic greedy optimization algorithm may be used, as shown in FIG. 3C. In other words, if the greedy optimization method of FIG. 3B fails to create a match between the sum of the set of target invoices and the payment amount, then the dynamic greedy optimization method may be performed.

FIG. 3C shows an example of the dynamic greedy optimization method. FIG. 3C shares the same reference numerals as FIG. 3B, referring to similar objects having similar descriptions. Thus, the same three invoices (i.e., test entities including the invoice 1 (308), the invoice 2 (310), and the invoice 3 (312)) are present, as is the same payment (i.e., source entity (314) with constraint) having the same constraint (315) (i.e., the constraint is the amount of the payment).

Again, the invoices are scored by the matching machine learning model, as indicated in column (330). However, this time, the greedy optimization algorithm described with respect to FIG. 3B is repeated multiple times. Initially, the same greedy optimization algorithm is performed on the invoice 2, which returns one candidate set of invoices (i.e., the invoice 1, representing $50).

Then, the greedy optimization algorithm is repeated again, but this time starting with the invoice 3 (312), because the invoice 3 (312) is the second invoice in the ordered list of invoices (again, the list ordered by scoring by the matching machine learning model). This time, the greedy optimization algorithm stops once invoice 3 is combined with invoice 1 on the list, because the combined amount would be $160, in violation of the constraint. Thus, another candidate set of invoices is returned (i.e., the invoice 3 (312), representing $60).

The greedy optimization algorithm is repeated yet again, this time starting at the invoice 1 (308), because the invoice 1 (308) is the third invoice in the ordered list of invoices. This time, the greedy optimization algorithm stops immediately, because the amount of invoice 1 ($100) exactly equals the constraint (315) of $100.

Thus, three sets of candidate target entities (invoices) are considered. The combinations are 1) Invoice 2 (310) ($50), 2) Invoice 3 (312) ($60), and invoice 1 (308) ($100). As can be seen, interestingly, the matching machine learning model assigned invoice 1 (308) the lowest probability of matching the payment (314). Nevertheless, the third set of candidate test entities (the invoice 1 (308)) is the solution to the constraint-based one-to-many matching problem in FIG. 3C, because of the three sets of candidate target entities, only the third set (the invoice 1 (308)) exactly matches the constraint (315). Accordingly, the invoice 1 (308), in this example, is returned as the optimized combination of test entities.

A computer performs O(N) calculations to solve the dynamic greedy optimization algorithm shown in FIG. 3C, plus the calculations performed to execute the matching machine learning model. Here, “N” is 3. Thus, 3 calculations were performed. However, had the problem been solved directly, then 3N=33=9 calculations would have been performed. While in the simple example of FIG. 3A through FIG. 3C the computational savings may appear to be minimal, as shown above, the computational savings increases exponentially with the number of test entities.

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

For example, as shown in FIG. 4A, the computing system (400) may include one or more computer processor(s) (402), non-persistent storage device(s) (404), persistent storage device(s) (406), a communication interface (408) (e.g., Bluetooth interface, infrared interface, network interface, optical interface, etc.), and numerous other elements and functionalities that implement the features and elements of the disclosure. The computer processor(s) (402) may be an integrated circuit for processing instructions. The computer processor(s) (402) may be one or more cores, or micro-cores, of a processor. The computer processor(s) (402) includes one or more processors. The computer processor(s) (402) may include a central processing unit (CPU), a graphics processing unit (GPU), a tensor processing unit (TPU), combinations thereof, etc.

The input device(s) (410) may include a touchscreen, keyboard, mouse, microphone, touchpad, electronic pen, or any other type of input device. The input device(s) (410) may receive inputs from a user that are responsive to data and messages presented by the output device(s) (412). The inputs may include text input, audio input, video input, etc., which may be processed and transmitted by the computing system (400) in accordance with one or more embodiments. The communication interface (408) may include an integrated circuit for connecting the computing system (400) to a network (not shown) (e.g., a local area network (LAN), a wide area network (WAN) such as the Internet, mobile network, or any other type of network) or to another device, such as another computing device, and combinations thereof.

Further, the output device(s) (412) may include a display device, a printer, external storage, or any other output device. One or more of the output device(s) (412) may be the same or different from the input device(s) (410). The input device(s) (410) and output device(s) (412) may be locally or remotely connected to the computer processor(s) (402). Many different types of computing systems exist, and the aforementioned input device(s) (410) and output device(s) (412) may take other forms. The output device(s) (412) may display data and messages that are transmitted and received by the computing system (400). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a solid-state drive (SSD), compact disk (CD), digital video disk (DVD), storage device, a diskette, a tape, flash memory, physical memory, or any other computer readable storage medium. Specifically, the software instructions may correspond to computer readable program code that, when executed by the computer processor(s) (402), is configured to perform one or more embodiments, which may include transmitting, receiving, presenting, and displaying data and messages described in the other figures of the disclosure.

The computing system (400) in FIG. 4A may be connected to, or be a part of, a network (420). For example, as shown in FIG. 4B, the network (420) may include multiple nodes (e.g., node X (422) and node Y (424), as well as extant intervening nodes between node X (422) and node Y (424)). Each node may correspond to a computing system, such as the computing system (400) shown in FIG. 4A, or a group of nodes combined may correspond to the computing system (400) shown in FIG. 4A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (400) may be located at a remote location and connected to the other elements over a network.

The nodes (e.g., node X (422) and node Y (424)) in the network (420) may be configured to provide services for a client device (426). The services may include receiving requests and transmitting responses to the client device (426). For example, the nodes may be part of a cloud computing system. The client device (426) may be a computing system, such as the computing system (400) shown in FIG. 4A. Further, the client device (426) may include or perform all or a portion of one or more embodiments.

The computing system (400) of FIG. 4A may include functionality to present data (including raw data, processed data, and combinations thereof) such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown, as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or a semi-permanent communication channel between two entities.

The various descriptions of the figures may be combined and may include, or be included within, the features described in the other figures of the application. The various elements, systems, components, and steps shown in the figures may be omitted, repeated, combined, or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before”, “after”, “single”, and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
receiving a processor command to execute a constraint-based one-to-many matching problem comprising matching a source entity to a plurality of target entities selected from a plurality of test entities, wherein the constraint-based one-to-many matching problem further comprises a constraint that constrains permitted combinations of the plurality of target entities;
executing a matching machine learning model on the source entity and the plurality of test entities to generate a plurality of scores representing a plurality of degrees of match between the source entity and corresponding ones of the plurality of test entities;
arranging the plurality of test entities in an ordered list according to the plurality of scores;
executing a greedy optimization algorithm that is constrained by the constraint to generate a plurality of combinations of the test entities, wherein each of the plurality of combinations satisfies the constraint;
selecting, from among the plurality of combinations of the test entities, an optimized combination of test entities from among the plurality of combinations of test entities, wherein the optimized combination of test entities is optimized relative to the constraint; and
storing the optimized combination of test entities as the plurality of target entities.

2. The method of claim 1, wherein:
the plurality of target entities comprises a first number of the plurality of target entities and the plurality of test entities has a second number of the plurality of test entities, and
the first number of the plurality of target entities is less than the second number of the plurality of test entities.

3. The method of claim 1, wherein the greedy optimization algorithm is executed a plurality of times according to a number of the plurality of test entities.

4. The method of claim 3, wherein each iteration of the greedy optimization algorithm begins with a next test entity in the ordered list.

5. The method of claim 1, wherein the greedy optimization algorithm is executed once for each of a number of the plurality of test entities and, on each execution of the greedy optimization algorithm, initiation of the greedy optimization algorithm begins with a subsequent test entity in the ordered list.

6. The method of claim 1, wherein:
the constraint-based one-to-many matching problem, when directly matching the source entity to the plurality of test entities, comprises a first computational complexity on a first complexity order of 2^{N},
the constraint-based one-to-many matching problem, when executing i) the matching machine learning model, ii) arranging the plurality of test entities, and iii) executing the greedy optimization algorithm, comprises a second computational complexity on a second complexity order of N, and
N represents a number of the plurality of test entities.

7. The method of claim 6, wherein N is at least 50.

8. The method of claim 1, further comprising:
generating a data structure that stores information indicating that the source entity is matched to the plurality of target entities; and
transmitting the data structure to an information processing algorithm.

9. The method of claim 8, wherein the data structure further comprises the source entity and the plurality of target entities.

10. A system comprising:
a computer processor;
a data repository in communication with the computer processor and storing:
a processor command to execute a constraint-based one-to-many matching problem comprising matching a source entity to a plurality of target entities selected from a plurality of test entities, wherein the constraint-based one-to-many matching problem further comprises a constraint that constrains permitted combinations of the plurality of target entities,
a plurality of scores representing a plurality of degrees of match between the source entity and corresponding ones of the plurality of test entities,
a plurality of combinations of the test entities, and
an optimized combination of test entities, wherein the optimized combination of test entities is optimized relative to the constraint;
a matching machine learning model which, when executed by the computer processor on the source entity and the plurality of test entities, generate the plurality of scores;
a greedy optimization algorithm which, when executed by the computer processor, is constrained by the constraint to generate the plurality of combinations of test entities, wherein each of the plurality of combinations satisfies the constraint; and
a server controller which, when executed by the computer processor, performs a computer-implemented method comprising:
arranging the plurality of test entities in the ordered list according to the plurality of scores;
selecting, from among the plurality of combinations of the test entities, the optimized combination of test entities from among the plurality of combinations of test entities; and
storing the optimized combination of test entities as the plurality of target entities.

11. The system of claim 10, wherein:
the plurality of target entities has a first number of the plurality of target entities and the plurality of test entities has a second number of the plurality of test entities, and
the first number of the plurality of target entities is less than the second number of the plurality of test entities.

12. The system of claim 10, wherein the greedy optimization algorithm is executed a plurality of times according to a number of the plurality of test entities.

13. The system of claim 12, wherein each iteration of the greedy optimization algorithm begins with a next test entity in the ordered list.

14. The system of claim 10, wherein:
the constraint-based one-to-many matching problem, when directly matching the source entity to the plurality of test entities, comprises a first computational complexity on a first complexity order of 2^{N},
the constraint-based one-to-many matching problem, when executing i) the matching machine learning model, ii) arranging the plurality of test entities, and iii) executing the greedy optimization algorithm, comprises a second computational complexity on a second complexity order of N, and
N represents a number of the plurality of test entities.

15. The system of claim 14, wherein N is at least 50.

16. The system of claim 10, wherein the computer-implemented method further comprises:
generating a data structure that stores information indicating that the source entity is matched to the plurality of target entities; and
transmitting the data structure to an information processing algorithm.

17. The system of claim 16, wherein the data structure further comprises the source entity and the plurality of target entities.

18. A method comprising:
receiving a processor command to execute a constraint-based one-to-many matching problem comprising matching a source entity to a plurality of target entities selected from a plurality of test entities, wherein:
the constraint-based one-to-many matching problem further comprises a constraint that constrains permitted combinations of the plurality of target entities,
the plurality of target entities comprises a first number of the plurality of target entities and the plurality of test entities comprises a second number of the plurality of test entities, and
the first number of the plurality of target entities is less than the second number of the plurality of test entities,
executing a matching machine learning model on the source entity and the plurality of test entities to generate a plurality of scores representing a plurality of degrees of match between the source entity and corresponding ones of the plurality of test entities;
arranging the plurality of test entities in an ordered list according to the plurality of scores;
executing a greedy optimization algorithm constrained by the constraint to generate a plurality of combinations of the test entities, wherein:
each of the plurality of combinations satisfies the constraint,
the greedy optimization algorithm is executed once for each of a number of the plurality of test entities and, on each execution of the greedy optimization algorithm, initiation of the greedy optimization algorithm begins with a subsequent test entity in the ordered list, and
the plurality of combinations of the test entities includes each of a plurality of sets of combinations of test entities generated by a plurality of executions of the greedy optimization algorithm on the plurality of test entities;
selecting, from among the plurality of combinations of the test entities, an optimized combination of test entities from among the plurality of combinations of test entities, wherein the optimized combination of test entities is optimized relative to the constraint; and
storing the optimized combination of test entities as the plurality of target entities.

19. The method of claim 18, wherein:
the constraint-based one-to-many matching problem, when directly matching the source entity to the plurality of test entities, comprises a first computational complexity on a first complexity order of 2^{N},
the constraint-based one-to-many matching problem, when executing i) the matching machine learning model, ii) arranging the plurality of test entities, and iii) executing the greedy optimization algorithm, comprises a second computational complexity on a second complexity order of N, and
N represents a number of the plurality of test entities.

20. The method of claim 18, further comprising:
generating a data structure that stores information indicating that the source entity is matched to the plurality of target entities, wherein the data structure further comprises the source entity and the plurality of target entities; and
transmitting the data structure to an information processing algorithm.
